(19) United States
(12) Patent Application Publication
(10) Pub. No.: US 2009/0143059 A1
(43) Pub. Date: Jun. 4, 2009

(54) System and method remote servicing of a wireless data processing device

(75) Inventors: Joe Freeman Britt, JR., Los Gatos, CA (US); Leslie Hamilton, Santa Ana, CA (US); Vic Gee, Fremont, CA (US)

Correspondence Address: MICROSOFT CORPORATION, ONE MICROSOFT WAY, REDMOND, WA, 98052, US

(73) Assignee: Danger, Inc.

(21) Appl. No.: 11/417,332

(22) Filed: May 2, 2006

(51) Int. Cl. H04M 3/00

(52) U.S. Cl. 455/419

(57) ABSTRACT

A system and method for remotely servicing a wireless data processing device over a telephony audio channel. For example, a method is described for remotely debugging a wireless data processing device from a service, the wireless device capable of communicating over both a data channel and a telephony channel, the method comprising: receiving a remote diagnostic session request at the service from a wireless data processing device; establishing a telephony-based communication channel with the wireless data processing device if a telephony-based communication channel is not already established; entering codes via the telephone keypad at the service to diagnose the wireless data processing device and transmitting the codes to the wireless data processing device, the codes causing the wireless data processing device to perform one or more operations identified by the codes; and receiving the results of the operations at the service, the results usable for the diagnosis of a problem with the wireless data processing device.

### BACKGROUND OF THE INVENTION

1. Field of the Invention

This invention relates generally to the field of data processing systems. More particularly, the invention relates to an improved architecture and method for remotely servicing of a wireless data processing device.

2. Description of the Related Art

Various types of personal wireless data processing devices are available today including cell phones, personal digital assistants (“PDAs”), and portable video games, to name a few. Problems may arise at some point during the device's life through errors existing in the software or firmware of the device. For example, a user may unknowingly download a new application or game with a virus embedded in the program. When the application or game is installed, the virus may delete essential files required for normal operation of the device. As another example, downloaded software that is not fully compatible with the device may corrupt existing software and/or cause glitches in the operation of the device.

As a result, many service providers and device manufacturers provide technical support to end users. The users typically call a technical support number and a technical support operator discusses the problem with the user and attempts to verbally walk the user through a series of steps in an attempt to repair the device.

Several problems exist with current technical support services for wireless data processing devices. For example, given the vast difference in the technical expertise of end users, an operator may spend a significant amount of time determining each user's technical understanding and/or tutoring the user on the technical aspects of the device. In addition, verbal descriptions by the user of a technical problem may not be communicated efficiently to the operator. Thus, the operator may be unable to effectively evaluate the problem based on explanations given by the end user. Furthermore, certain information necessary to diagnose a problem may not be available to the user, or the user may not know what information is relevant to diagnose a problem (e.g., the problem is in software not viewable by the user).

Accordingly, what is needed is an improved system and method for servicing a wireless data processing device.

### SUMMARY

A system and method are described for remotely servicing a wireless data processing device over a telephony audio channel. For example, in one embodiment, a method is described for remotely debugging a wireless data processing device from a service, the wireless device capable of communicating over both a data channel and a telephony channel, the method comprising: receiving a remote diagnostic session request at the service from a wireless data processing device; establishing a telephony-based communication channel with the wireless data processing device if a telephony-based communication channel is not already established; entering codes via the telephone keypad at the service to diagnose the wireless data processing device and transmitting the codes to the wireless data processing device, the codes causing the wireless data processing device to perform one or more operations identified by the codes; and receiving the results of the operations at the service, the results usable for the diagnosis of a problem with the wireless data processing device.

### BRIEF DESCRIPTION OF THE DRAWINGS

A better understanding of the present invention can be obtained from the following detailed description in conjunction with the following drawings, in which:

FIG. 1 illustrates a connection between a wireless data processing device and a service.

FIG. 2 illustrates the architecture of the service as it pertains to an embodiment of the invention.

FIG. 3 illustrates the architecture of the service as it pertains to another embodiment of the invention.

FIG. 4 illustrates the architecture of the service as it pertains to another embodiment of the invention.

FIG. 5a illustrates the architecture of the service as it pertains to another embodiment of the invention.

FIG. 5b illustrates the architecture of a data processing device according to one embodiment of the invention.

FIG. 6 is a flow-chart of the procedure for remotely servicing the wireless data processing device.

FIG. 7 is a flow-chart of the procedure of creating a backup of user information from the data processing device when performing a remote diagnostic check session of FIG. 6.

FIG. 8 is a flow-chart of the procedure of determining a problem with the device when performing a remote diagnostic check session of FIG. 6 with the service of FIG. 2.

FIG. 9 is a flow-chart of the procedure of determining a problem with the device when performing a remote diagnostic check session of FIG. 6 with the service of FIG. 3.

FIG. 10 is a flow-chart of the procedure for remotely servicing the wireless data processing device by the embodiment of the present invention illustrated in FIGS. 5a-b.

### DETAILED DESCRIPTION OF PREFERRED EMBODIMENTS

Described below is a system and method for remote servicing of a wireless data processing device. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

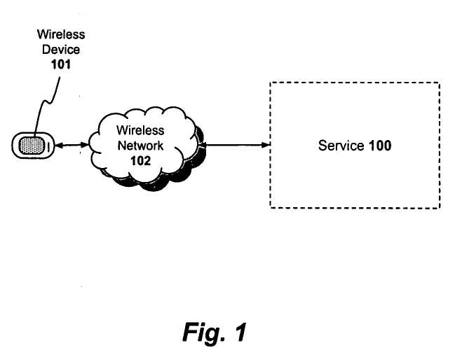

Embodiments of the invention may be implemented on a data processing service 100 such as that illustrated generally in FIG. 1. In one embodiment, the service 100 acts as a proxy between a wireless data processing device 101, with which the service 100 is communicably coupled to through the wireless network 102, and any external servers with which the service 100 communicates. One embodiment of a service 100 is described in the U.S. Pat. No. 6,721,804, entitled PORTAL SYSTEM FOR CONVERTING REQUESTED DATA INTO A BYTECODE FORMAT BASED ON A PORTAL DEVICE'S GRAPHICAL CAPABILITIES, Ser. No. 09/714,897, filed Nov. 15, 2000 (hereinafter “Network Portal Application”), which is assigned to the assignee of the present application and which is incorporated herein by reference.

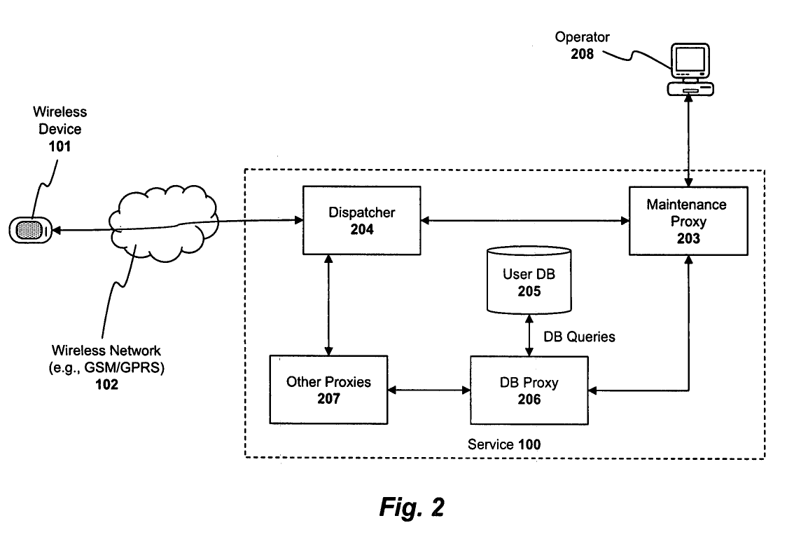

FIG. 2 illustrates one embodiment of the invention which includes a Maintenance Proxy 203 to perform a remote diagnostic check session on the device 101, a Dispatcher 204 to communicably connect the Maintenance Proxy 203 to the device 101 through the wireless network 102, a User Database 205 to store user information on the service (e.g., backups of user information on each device 101 that communicates with the service 100), a Database Proxy 206 to manage queries to the User Database 205, and other proxies 207 that may perform other functions within the service 100 (e.g., managing email and/or interfacing with the internet). In the present embodiment, an operator 208 is communicably coupled to the service 100 in order to assist with remotely servicing the device 101 (e.g., via a Windows-based computer).

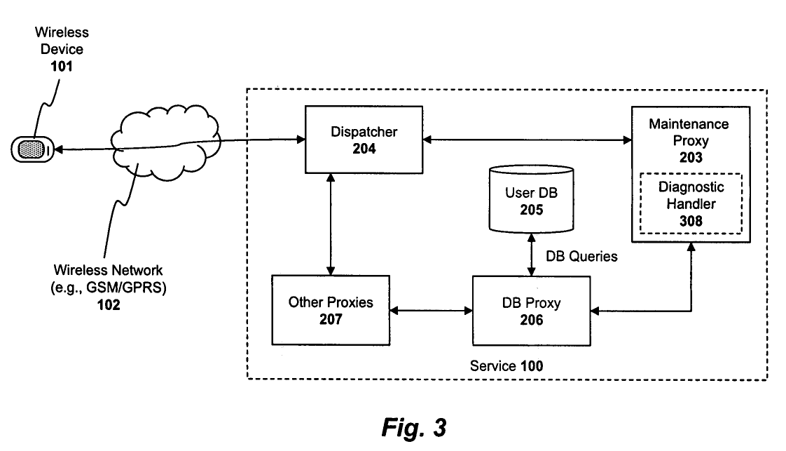

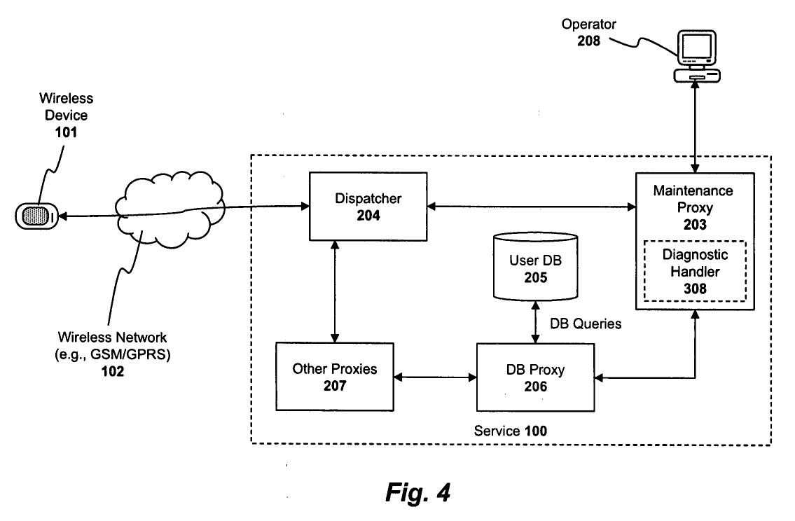

In another embodiment of the invention, the remote diagnostic check session may be automated via a diagnostic handler 308 within the Maintenance Proxy 203, as illustrated in FIG. 3. In yet another embodiment of the present invention, portions of the remote diagnostic check session may be automated in the Diagnostic Handler 308 while other portions of the remote diagnostic check session may be assisted by an operator 208 communicably coupled to the service 100, as illustrated in FIG. 4.

In a further embodiment of the present invention, the remote diagnostic check session may include the operator 208 communicating with the device 101 over a telephony audio channel, such as over a Public Switched Telephone Network (PSTN 509), and/or communicating with the device 101 through the service 100.

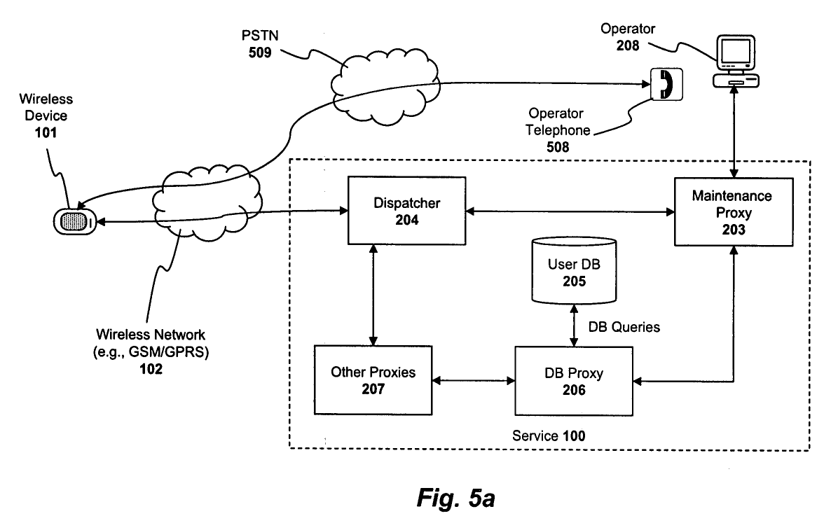

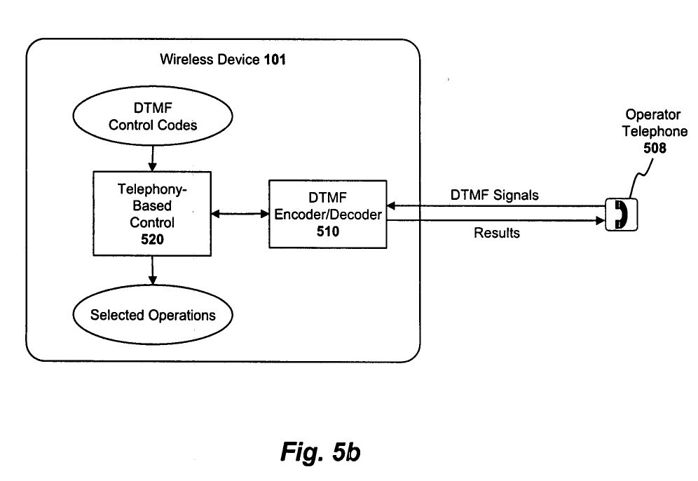

In one embodiment illustrated in FIG. 5a, the device 101 is communicably connected to the telephony audio channel (e.g., the public switched telephone network or “PSTN” 509) and the service 100 through a Global System for Mobile Communications (GSM) network 102. Thus, the device 101 may transmit/receive telephony audio signals over the GSM network and the PSTN 509 to/from the service 100.

In addition, the device 101 may transmit and receive data using the General Packet Radio Service (GPRS) provided on the GSM network 102. In other embodiments, the device 101 may transfer data using Short Message Service (SMS) or other data transmission services known to one skilled in the art. Although the embodiments of the invention described herein employ GSM/GPRS for the wireless network 102, the underlying principles of the invention are not limited to any particular type of network or communication protocol. For example, the device 101 may be communicably connected to the PSTN 509 and the service 101 through a Code Division Multiple Access (CDMA) network.

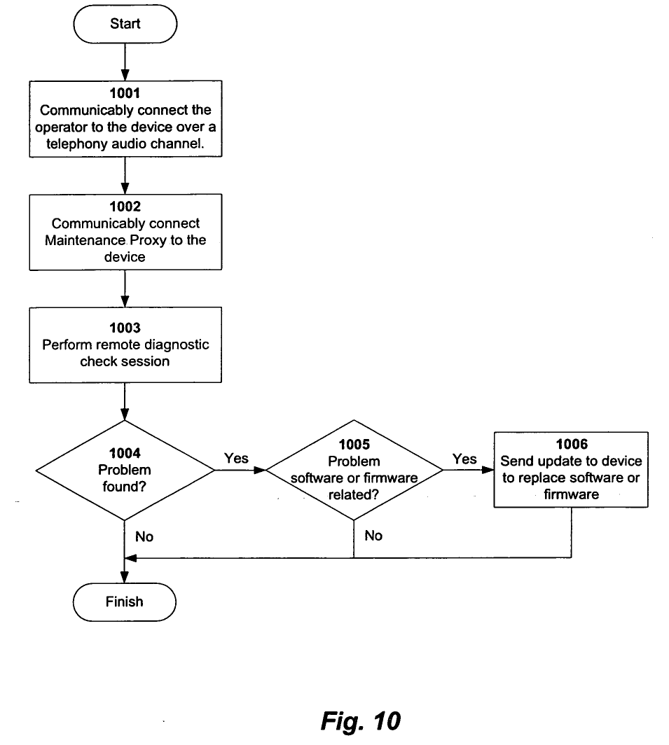

FIG. 5b illustrates one embodiment of a data processing device 101 which may be controlled via the telephony connection. In particular, this embodiment includes a Dual-Tone Multi Frequency (“DTMF”) encoder/decoder 510 for decoding DTMF signals generated from the keypad from the operator telephone 508 and encoding data generated by the wireless device 101 into DTMF signals. This embodiment also includes a telephony based control module 520 for executing operations on the device in response to decoded DTMF code sequences and providing the results to the encoder/decoder 510 for transmission to the service over the telephony audio channel. Additional details associated with this embodiment of the invention and specific examples of telephony-based remote control operations are described below with respect to FIG. 10.

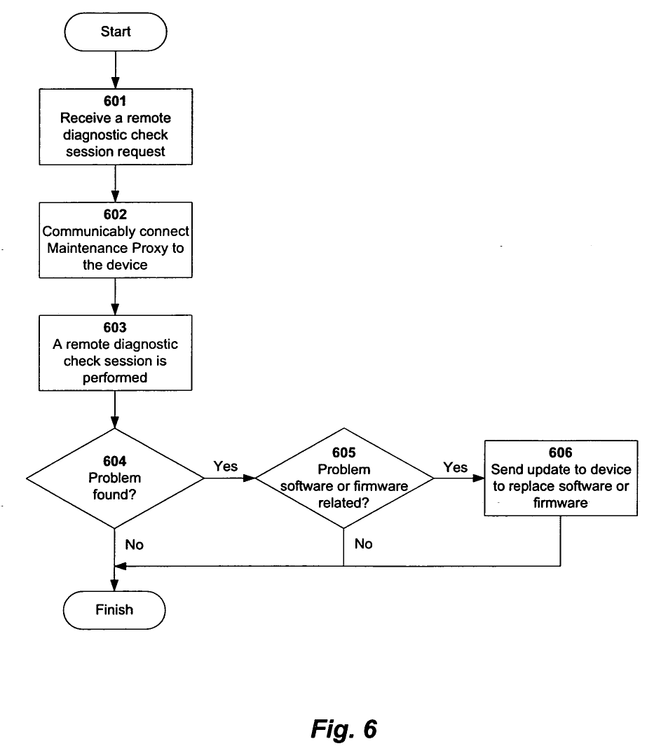

FIG. 6 illustrates one embodiment of a method of remotely servicing a wireless data processing device 101. Beginning with step 601, the service 100 receives a remote diagnostic check session request from the wireless data processing device 101. In one embodiment of the present invention, the remote diagnostic check session request may be initiated by the user when the user experiences problems with the operation of the device 101 (e.g., due to software or firmware). Alternatively, or in addition, the device 101 may contact the service 100 automatically upon detecting a problem in its software or firmware.

In initiating the diagnostic check session request, the user may call a special phone number that alerts the service 100 that the user wishes a remote diagnostic check session to be performed. For example, specific phone numbers are able to be dialed by all cellular telephones. Thus, one of those numbers may be used by the service 100 for requesting a remote diagnostic check session. In other embodiments of the present invention, the remote diagnostic check session request may be initiated through a message sent in Short Message Service (SMS) format, an email, a special packet of information sent to the service 100, or any other forms known to one skilled in the art.

Once the remote diagnostic check session request is received by the service 100, at step 602 the Maintenance Proxy 203 is communicably connected to the wireless data processing device 101 via the dispatcher 204. Once the Maintenance Proxy 203 is communicably coupled to the device 101, at step 603, the Maintenance Proxy 203 establishes a remote diagnostic check session on the wireless data processing device 101. More specific steps that may occur in one embodiment of the remote diagnostic check session are described below.

After the check session is performed at 603, at step 604 the service 100 determines whether a problem with the device 101 was found during the remote diagnostic check session. If no problem was found, then the flowchart of FIG. 6 is exited. In other embodiments of the present invention, the user may be notified that service 100 was unable to find any problems with the device. The user may also be given a number to call and/or a reference number in connection with the recent remote diagnostic check session.

If a problem was found, then at step 605, the service 100 determines if the detected problem is in software or firmware. If the problem is not detected in software or firmware then, as illustrated, the flowchart in FIG. 6 is exited. That is, if the problem is not related to software or firmware, the service 100 determines that the problem cannot be fixed remotely. Thus, in one embodiment of the present invention, the user may be notified of the nearest repair facility for the device 101. Also, the user may be given a phone number to call for additional information related to the detected problem.

If, however, the problem found was related to software or firmware, then in step 606 an update is sent by the service 100 to the wireless data processing device 101 via the dispatcher 204. In one embodiment of the present invention, the update overwrites the portion of software or firmware where the problem was found. In other embodiments of the present invention, the update may remove any problematic programs or scripts, correct the problem through rewriting any problematic code, or format a portion of memory storing the problematic software or firmware. It will be apparent to one skilled in the art that a variety of methods of correcting problems in software and hardware exist, and thus the present invention should not be limited to any of the embodiments described in the present application. Once the update is sent to the device 101, the flowchart in FIG. 6 is exited.

It will be apparent to one skilled in the art that not all steps in FIG. 6 may be required, that the steps may not be exclusive of any additional steps, and that the steps need not be performed in the sequence as described.

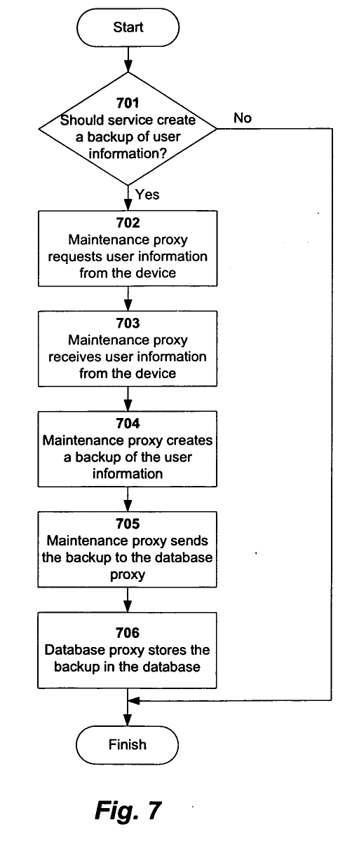

FIG. 7 illustrates one embodiment of a method for creating and storing a backup of user information retrieved from the device 101 during the remote diagnostic check session (e.g., in step 603 of FIG. 6). At 701, the service 100 determines whether it should create a backup of the user information stored on the device 101. If a backup is not to be created, then the flowchart in FIG. 7 is exited. If a backup is to be created, then process flows to step 702 where the Maintenance Proxy 203 requests user information from the device 101 (e.g., account handles and passwords, documents, emails, preferences, etc).

Upon the maintenance proxy 203 requesting the user information from the device, the process flows to step 703, where the maintenance proxy receives the user information from the device 101. It will be apparent to one skilled in the art that the device may be unable to send the user information and/or that the information requested/received may be a portion or all of the total data stored on the device 101.

Once the user information is received from the device 101 by the maintenance proxy 203, the process flows to step 704 where the maintenance proxy 203 creates a backup of the received user information. In another embodiment of the present invention, the information may be used to update a preexisting backup stored in the user database 205. As such, the user information may be sent from the device 101 directly to the database proxy to update the existing backup.

Once the backup is created by the maintenance proxy 203 in step 704, the process flows to step 705 where the maintenance proxy 203 sends the backup to the database proxy 206 to store in the user database 205. In another embodiment of the present invention, the backup may be stored in a medium external to the service (e.g., a reserved area of the device 101 or an external server).

Upon sending the backup to the database proxy 206, the process flows to step 706 where the database proxy 206 stores the backup in the user database 205. In one embodiment of the invention, each user that communicates with the service 100 may have a separate folder in the user database 205 where the backup is stored.

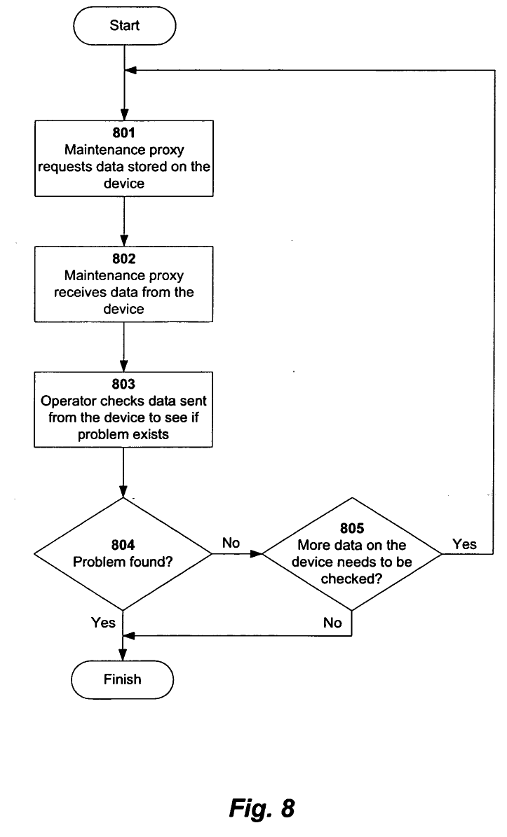

FIG. 8 illustrates one embodiment of a process for determining a problem with the device 101 when performing a remote diagnostic check session (e.g., step 603 of FIG. 6) in which a live operator 208 is communicably coupled to the device. Beginning with step 801, the maintenance proxy 203 requests data stored on the device 101. In one embodiment of the invention, the operator 208 queries the wireless data processing device 101 for information that may help pinpoint a problem that may exist within the device 101.

For example, the operator 208 may request a log of operations performed by the wireless data processing device 101 (e.g., the last 20 actions, programs opened, or functions performed by the device 101). In another example, the operator 208 may request a snapshot of what the device 101 is displaying on its screen (e.g., an error message). Alternatively, the operator 208 may request a copy of the underlying information displayed by the device 101. In one embodiment, a subset of information displayed on the device 101 is sent to the service 100 in order to conserve bandwidth.

In another example, the operator 208 may query the device 101 via the maintenance proxy 203, effectively “asking” the device 101 a series of questions in order to determine the existence of a problem within the device 101. For example, the operator 208 may determine if the device 101 experiences errors during specific sequences or may attempt to determine if the user is attempting to perform unrecognized actions with the device.

Once the maintenance proxy 203 requests certain data stored on the device 101, the process moves to step 802 where the maintenance proxy 203 receives the requested data from the wireless data processing device 101. In one embodiment of the present invention, the device 101 may be unable to send all of the requested data to the service 100. Therefore, the device 101 may send only a portion of the requested data or the device 101 may send a response to the service 100 that it is unable to complete the request. If only a portion is received by the service 100 or the device 101 responds that it is unable to complete the request, the operator 208 may be notified of such.

Once the data is received by the maintenance proxy 203, process flows to step 803 where the operator 208 checks the data sent from the wireless data processing device 101 to see if a problem exists within the device 101. In one embodiment of the present invention, the process of the operator 208 querying, receiving, and checking the data from the wireless data processing device 101 (steps 801, 802, and 803) may be a system where the operator verbally asks a question of the device 101 (e.g., “Can you, the device, boot up properly?”). The maintenance proxy 203 may then interpret the question into a series of requests for data that are sent to the device 101. Once the data is received, the maintenance proxy 203 may help determine whether, for example, the device 101 is properly booting up. Afterwards, the maintenance proxy 203 sends the result to the operator 208 in the form of a voice synthesized response to the operator 208.

In another embodiment of the present invention, the operator 208 uses keystrokes on a telephony device or may have a telephony interface with the service 100. By way of example, the operator 208 presses the “1” key to ask if the device 101 is properly booting up. In one embodiment, the device 101 sends a voice synthesized response as an answer to the operator's question.

After the operator 208 checks the data to see if a problem exists, the process flows to decision block 804 where the service 100 determines whether a problem was found. If a problem was found, then FIG. 8 is exited and the process moves to decision block 604 of FIG. 6. If no problem was found, the process flows to decision block 805 where the service 100 determines whether more data on the wireless data processing device 101 needs to be checked. For example, the operator 208 may have more questions to ask the device 101 or wish to query for more data from the device 101. Also, the maintenance proxy 203 may determine that obtaining more data from the wireless data processing device 101 is necessary.

If more data on the device needs to be checked, then the process reverts back to step 801 and repeats until a problem is found or no more data needs to be checked. If no more data needs to be checked, then FIG. 8 is exited and process flows to decision block 604 of FIG. 6. In other embodiments of the preset invention, the process of performing a remote diagnostic check session may include searching for and finding multiple problems within the device 101 or performing non-required updates to a device 101 (e.g., updating the firmware version) while the wireless data processing device 101 is connected for the remote diagnostic check session. It will be apparent to one skilled in the art that not all steps in FIG. 8 may be required, that the steps may not be exclusive of any additional steps, and that the steps may not need to be performed in the sequence as described. Therefore, the invention should not be limited to the embodiment described in FIG. 8.

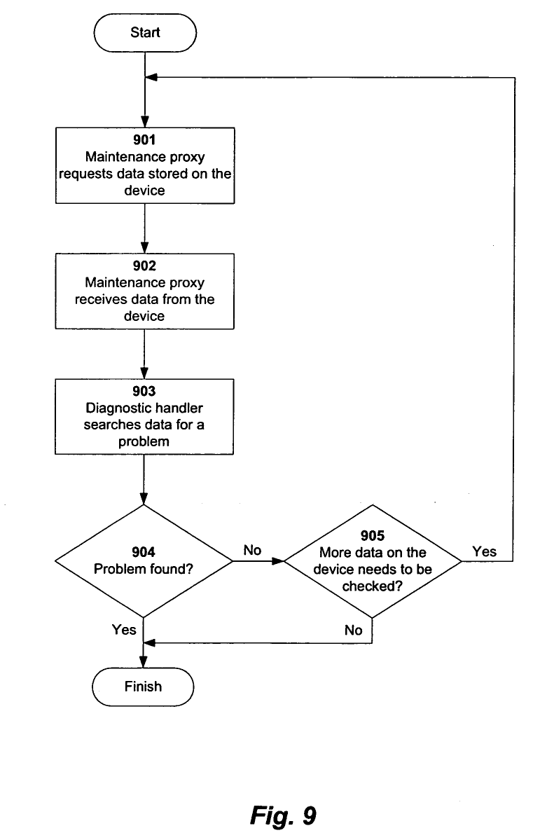

FIG. 9 is a flow-chart of one embodiment of a process of determining a problem with the device when performing a remote diagnostic check session via the architecture of FIG. 3, including the diagnostic handler 308. The method is similar to the flowchart of FIG. 8 (for an operator 208), wherein the device 101 may be queried for data, the data may be received by the service 100, and the diagnostic handler 308 may check the data to determine if a problem exists within the device (steps 901, 902, and 903, respectively). If a problem is then found in decision block 904 or no more data on the device needs to be checked in decision block 905, then the flowchart of FIG. 9 is exited and process flows to decision block 604 of FIG. 6. If a problem is not found and more data needs to be checked (decision blocks 904 and 905), then process reverts to step 901.

In another embodiment of the present invention, the remote diagnostic check session may be performed by an automatic diagnostic handler 308 and an operator 208 working together, as illustrated in FIG. 4. For example, the operator 208 may ask operational questions of the device 101 (e.g., “What programs does the user run and what sequences does the user perform?”) while the diagnostic handler 308 checks the memory of the wireless data processing device 101 to determine if a memory corruption exists in the device 101. It will be apparent to one skilled in the art that multiple means of examining the data of the device 101 by a person (operator 208) and an automatic service (diagnostic handler 308) exist. Therefore, the present invention should not be limited to the scope of any of the above described embodiments.

FIG. 10 illustrates another embodiment of a method of remotely servicing a wireless data processing device 101 using the architecture illustrated in FIGS. 5a-b. Beginning with step 1001, the user of the device 101 dials a number for customer service, thereby contacting the operator 208. The operator 208 may then determine that a remote diagnostic session should be initiated. In one embodiment, the operator 208 asks the user to dial a special code (e.g., *821) which initiates the diagnostic session over the PSTN 509 (or other type of telephony audio channel). Alternatively, the operator may initiate the control session after the device is connected to the operator's telephone 508 by entering a predefined code via the telephone 508 keypad (e.g., *2886#). Returning to FIG. 5a, in this embodiment, the DTMF signals transmitted from the telephone 508 over the telephony connection are decoded by the DTMF decoder/encoder 510 and interpreted by the telephony-based control module 520, thereby causing the device to enter into a remote control state in which the operator 208 controls the device via the keypad on the telephone 508. Once in the remote control state, information collected while under the control of the operator 208 is encoded by the DTMF encoder/decoder and transmitted over the telephony channel to the operator's telephone (or other device capable of decoding the DTMF signals).

In another embodiment, the operator calls the device 101 on a special number to establish the telephony connection, thereby indicating to the device 101 that the operator 208 is calling (as distinguished from a standard incoming call). In yet another embodiment of the present invention, the operator 208 sends an instruction to the device 101 through the service 100 that, when executed by the device 101, causes the device 101 to call the operator 208. Various additional mechanisms for establishing the remote control debug session may be employed while still complying with the underlying principles of the invention.

Once a telephony-based control connection is established between the operator 208 and the device 101, the process flows to step 1002 where the maintenance proxy 203 is communicably connected to the device 101. At this stage two separate connections are established with the device: one over a telephony channel (e.g., PSTN/GSM) and one over a data channel (e.g., GPRS/TCP-IP). In one embodiment, the telephony audio channel is used to control the device and/or gather information in the form of a “Question and Answer” session. Concurrently, the data channel may be used by the operator to extract data from the device 101 and/or to send the device 101 a software or firmware update.

It should be noted, however, that the data channel between the device 101 and the service 100 may not be required as the operator 208 may be able to correct any problems through the telephony audio channel. For example, as mentioned above, in one embodiment, a series of DTMF signals (or other type of audio signals) are generated by the DTMF encoding portion of the encoder/decoder 510 and transmitted from the wireless device to the operator's telephone to communicate information to the operator. In this embodiment, a DTMF decoder and associated control logic (e.g., similar to those illustrated in FIG. 5b) may be configured within the operator's telephone 508, or other device connected to the telephone line (e.g., the operator's computer 208). The DTMF decoder and associated control logic at the service 100 translates the series of code sequences into text, graphics or speech in order to convey the information to the operator. This embodiment is particularly useful in situations where the data connection is unavailable (e.g., because the device is malfunctioning).

In another embodiment, rather than using DTMF signals, the device itself may transmit synthesized speech to the operator over the telephony audio channel. The synthesized speech may be generated using various well known text-to-speech synthesis techniques.

After step 1002, the process flows to step 1003 where the remote diagnostic test session is performed. As mentioned above, in one embodiment, during the remote diagnostic test session, the operator 208 uses the keypad of the telephone 508 to control the device and/or collect information. For example, the operator 208 may instruct the device 101 to reset specific registers or to reboot by pressing a specific key sequence, such as *55.The DTMF code is then decoded by the encoder/decoder 510 and interpreted by the telephony-based control module 520 which executes the requested operation. By way of another example, the operator 208 may press a code (e.g., #87) to instruct the device 101 to send its current display settings. In response, the current display setting are collected by the telephony-based control module 520 and provided to the encoder/decoder 510 for DTMF encoding (or other type of encoding).

To illustrate the benefits of the foregoing techniques, the following is an exemplary interaction between the wireless device 101 and a customer support operator:
<USER>: “Man, I can't connect to the network. I guess I'll call customer support at 611.”
   User Calls Customer Support
<Customer Support Rep (CSR)>: “Hello sir, how can I help you?”
<USER>: “I can't log in to my account!”
<CSR>: “OK, sir, let me check on a few things.”
   CSR gets device attention with a special “ATTENTION” sequence of touch-tones from her telephone dialpad:
   *2886#
   Device recognizes “ATTENTION” sequence and responds with synthesized speech:
<Device>: “READY.”
   CSR queries current cell tower:
   *2355#
<Device>: “3-1-0-1-7-0”
<CSR>: “OK, sir, I can tell from your tower that you are in Palo Alto, Calif. I see that the network is operating properly there, so that isn't the problem.”
   CSR queries the APN (Access Point Name), used for connecting to the appropriate data service:
   *2767#
<Device>: “i-n-t-e-r-n-e-t-2”
<CSR>: “OK, sir, I see the problem. Your device has been configured with the incorrect APN for your Sidekick account. I can fix that for you.”
   CSR instructs the device to select the appropriate APN:
   *2767#
<Device>: “Enter letters and numbers for APN. Enter # to end, * to cancel operation.”
   CSR then enters the letters for “hiptop” as she would on a cellphone:
   44-444-7-8-666-7-# . . .
<Device>: “APN set to h-i-p-t-o-p”
<CSR>: “OK, sir, that should do it. I will hang up now, and your device should then connect. Please call us back if you have any more problems.”
<User>: “Thank you so much! What a great support system you have!”
<CSR>: “We aim to please sir. You have a great day.”

In another embodiment of the invention, rather then entering codes via the telephone keypad, the operator 208 may speak an instruction for the device 101 to execute. The device 101 may then use speech recognition techniques to decipher the instruction so that it can be executed by the device 101.

For the device 101 to communicate with the operator over the telephony audio channel, the device 101 may use a variety of different types of tones other than DTMF tones, sequences of clicks, or other audio signals which communicate information to the operator 208 in response to the operator's 208 instruction. For example, after the device 101 completes an instruction by the operator 208, the device may send a “beep” or designated series of “beeps” to the operator 208 to signify that the instruction execution is completed.

Thus, during the remote diagnostic check session, the operator 208 conducts a dialogue with the device 101 in order to determine if any problem exists with the device 101. During the session, the service 100 may create a backup of the data, software, and/or firmware on the device 101 (see FIG. 7). In another embodiment of the present invention, during the dialogue between the operator 208 and the device 101, data may be transferred from the device 101 to the service 100, as illustrated in FIG. 8.

Once the diagnostic check session has been performed in step 1003, process flows to decision block 1004 where the operator 208 determines whether a problem has been found with the device 101. If a problem was not identified, then the process ends and the flow-chart of FIG. 10 is exited. If a problem was found during the diagnostic check session, then process flows to decision block 1005 to determine if the problem is software or firmware related.

In decision block 1005, if the problem is not software and/or firmware related (e.g., a hardware problem), then the process ends and the flow-chart of FIG. 10 is exited. If the problem is software and/or firmware related, the process flows to step 1006 where an update is sent by the service 100 to the device 101 to correct the problem. In one embodiment of the invention, the update may correct only the infected portion of code containing the problem. In another embodiment of the invention, the update may replace most or all of the software and/or firmware stored on the device 101. Multiple methods of remotely updating the data on a wireless data processing may be employed. Therefore, the present invention should not be limited to any of the above described methods for updating the device.

Throughout the above discussion, a method was discussed for diagnosing one problem on the wireless data processing device. The present invention, though, may be implemented to diagnose any number of problems at the same time or in any sequence. Thus, some of the above steps may not be necessary and some steps may be repeated multiple times when implementing the present invention. Therefore, the present invention should not be limited to any of the above embodiments or examples used to describe the present invention.

Furthermore, embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although the embodiments described above employ DTMF encoding and decoding, communication between the device and service over the telephony channel may be accomplished using a variety of alternate encoding and modulation schemes. Accordingly, the scope and spirit of the invention should be judged in terms of the claims which follow.

What is claimed is:

1. A method for remotely debugging a wireless data processing device, the wireless device capable of communicating over both a data channel and a telephony channel comprising:
receiving a remote diagnostic session request from a wireless data processing device;
establishing a telephony-based communication channel with the wireless data processing device if a telephony-based communication channel is not already established;
entering codes via a telephone keypad to diagnose the wireless data processing device and transmitting the codes to the wireless data processing device over the telephony-based communication channel, the codes causing the wireless data processing device to perform one or more operations identified by the codes; and
receiving the results of the operations, the results usable for the diagnosis of a problem with the wireless data processing device.

2. The method as in claim 1 wherein the remote diagnostic session request is a telephone call to or from a special telephone number, the method further comprising:
entering a specified code via the telephone keypad to cause the wireless data processing device to enter into a remote control state in which it listens for and performs the specified operations in response to the codes entered via the telephone keypad.

3. The method as in claim 1 wherein the results comprise result codes indicating the results of the operations.

4. The method as in claim 1 wherein receiving comprises:
receiving the results over the established telephony-based communication channel.

5. The method as in claim 4 wherein the results are communicated from the wireless device in the form of synthesized speech, the synthesized speech verbally identifying information requested via the codes.

6. The method as in claim 1 wherein receiving comprises:
receiving the codes over a data channel independent of the established telephony-based communication channel.

7. The method as in claim 1 wherein the codes cause the wireless data processing device to modify specific parameters.

8. The method as in claim 1 wherein the codes cause the wireless data processing device to reboot.

9. The method as in claim 1 further comprising:
diagnosing the results of the operations transmitted from the wireless data processing device; and
responsively transmitting a firmware and/or software update over a data channel to the wireless data processing device.

10. The method of claim 1 wherein the codes request a copy of the information displayed on the wireless data processing device, the method further comprising:
receiving the copy of the information displayed on the wireless data processing device over a data channel in response to the request; and
diagnosing the problem with the wireless data processing device in response to receiving the copy of the information displayed on the wireless data processing device.

11. The method of claim 10 wherein the copy of the information displayed on the wireless data processing device is a snapshot of a display of the wireless data processing device.

12. The method of claim 1 wherein the results of the operations transmitted from the wireless data processing device includes a log of recent operations performed by the wireless data processing device, the method further comprising:
diagnosing the problem with the wireless data processing device in response to receiving the log of operations.

13. The method of claim 1 wherein receiving the remote diagnostic session request is transmitted in the form of an email message and/or a Short Message Service (SMS) message

14. The method of claim 1 further comprising:
in response to the transmitted codes, receiving user information for a user of the wireless data processing device;
creating a backup of the user information in response to receiving the user information; and
storing the backup in a service in response to creating the backup.

15. A system comprising a memory for storing program code, and a processor for processing the program code, the program code, when executed by the processor, causing the processor to perform the operations of:
receiving a remote diagnostic session request from a wireless data processing device;
establishing a telephony-based communication channel with the wireless data processing device if a telephony-based communication channel is not already established;
entering codes via a telephone keypad to diagnose the wireless data processing device and transmitting the codes to the wireless data processing device over the telephony-based communication channel, the codes causing the wireless data processing device to perform one or more operations identified by the codes; and
receiving the results of the operations, the results usable for the diagnosis of a problem with the wireless data processing device.

16. The system as in claim 15 wherein the remote diagnostic session request is a telephone call to or from a special telephone number and wherein the system includes additional program code to cause the processor to perform the additional operations of:
entering a specified code via the telephone keypad to cause the wireless data processing device to enter into a remote control state in which it listens for and performs the specified operations in response to the codes entered via the telephone keypad.

17. The system as in claim 15 wherein the results comprise result codes indicating the results of the operations.

18. The system as in claim 15 wherein receiving comprises:
receiving the results over the established telephony-based communication channel.

19. The system as in claim 18 wherein the results are communicated from the wireless device in the form of synthesized speech, the synthesized speech verbally identifying information requested via the codes.

20. The system as in claim 15 wherein receiving comprises:
receiving the codes over a data channel independent of the established telephony-based communication channel.

21. The system as in claim 15 wherein the codes cause the wireless data processing device to modify specific parameters.

22. The system as in claim 15 wherein the codes cause the wireless data processing device to reboot.

23. The system as in claim 15 wherein the system includes additional program code to cause the processor to perform the additional operations of:
diagnosing the results of the operations transmitted from the wireless data processing device; and
responsively transmitting a firmware and/or software update from the service to the wireless data processing device.

24. A machine-readable medium having program code stored thereon which, when executed by a machine, causes the machine to perform the operations of:
receiving a remote diagnostic session request from a wireless data processing device;
establishing a telephony-based communication channel with the wireless data processing device if a telephony-based communication channel is not already established;
entering codes via the telephone keypad at the service to diagnose the wireless data processing device and transmitting the codes to the wireless data processing device over the telephony-based communication channel, the codes causing the wireless data processing device to perform one or more operations identified by the codes; and
receiving the results of the operations at the service, the results usable for the diagnosis of a problem with the wireless data processing device.
